(19) United States
(12) Patent Application Publication
(10) Pub. No.: US 2014/0067656 A1
(43) Pub. Date: Mar. 6, 2014

(54) METHOD AND SYSTEM FOR FRAUD RISK ESTIMATION BASED ON SOCIAL MEDIA INFORMATION

(71) Applicants: Shlomo COHEN GANOR, Beit Zayit (IL); Or Peles, Tel Aviv (IL)

(72) Inventors: Shlomo COHEN GANOR, Beit Zayit (IL); Or Peles, Tel Aviv (IL)

(21) Appl. No.: 13/605,142

(22) Filed: Sep. 6, 2012

(51) Int. Cl. G06Q 20/38

(52) U.S. Cl. 705/39

(57) ABSTRACT

A system and method for estimating or calculating a fraud risk by receiving information related to a transaction, using (e.g., after retrieving, from or via a network) social media information related to a party participating in the transaction and calculating a risk score, associated with the transaction, based on the correlation or comparison between the social media information and the information related to the transaction.

### FIELD OF THE INVENTION

The present invention relates to the field of fraud risk estimation.

### BACKGROUND OF THE INVENTION

There is an increasing need for detecting fraudulent transactions, especially in a world of online financial transactions. Current fraud detection methods and technologies may fail to address subtle cases of fraud, where the transaction itself may appear genuine.

As network applications that build to allow exchange of user-generated content, also known as “social media applications” are becoming a common tool for interactive dialogue between organizations, communities, and individuals, using social media information for fraud risk estimation may be very effective and useful.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a high-level block diagram of a fraud risk estimation system according to embodiments of the present invention.

FIG. 2 is a schematic illustration of a fraud risk estimation system according to embodiments of the present invention.

FIG. 3 is a flowchart of a target association process according to embodiments of the present invention.

FIG. 4 is a flowchart of an exemplary key indicator function according to embodiments of the present invention.

FIG. 5 is a flowchart of an exemplary key indicator function according to embodiments of the present invention.

FIG. 6 is a flowchart of an exemplary key indicator function according to embodiments of the present invention.

FIG. 7 is a flowchart of an exemplary key indicator function according to embodiments of the present invention.

FIG. 8 is a flowchart of an exemplary key indicator function according to embodiments of the present invention.

FIG. 9 is a flowchart of a method for fraud risk estimation according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the embodiments of present invention may be practiced without these specific details. In other instances, well-known methods, procedures and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification and claims to describe two or more components, devices, elements, units, parameters, or the like. For example, “a plurality of devices” may include two or more devices.

When used herein, a social media “post”, “information”, or “interaction” may refer to any activity or entry of content over a social media channel, or on a social media website, for example, posting text or images (e.g., a FaceBook post, comment or status update), memberships or affiliations in groups, via voice, text, video, links to other webpage content, or by simply selecting a field, such as, to “like” or “accept a friend request” in, for example, Facebook, subscribing to a blog or signing up for tweets on Twitter. In addition to active posts or interaction, social media information or interactions may also be passive, such as, having an advertisement displayed in the user's social media account, receiving another author's post, automatic log-outs, automatic counters tracking behavior such as most recent post, etc.

When used herein, the term “transaction” may refer to any, transfer or exchange of information, transfer of details related to a transaction, e.g., including an exchange of money or currency for goods, services, rights to services and the like. For example, a transaction may include a transfer of funds which may be related to an exchange, purchase or a gift, e.g., a wire transfer, a transfer of funds from one account to another account, each account owned by the same person. A transaction may include a customer or user changing his or her address at an institution. A transaction when used herein is typically (but not limited to) a financial transaction. Typically, a transaction includes one or more parties. E.g., if Jane Smith is making a wire transfer from her on-line brokerage account at institution A to her checking account at bank B, Jane Smith is a party associated with the transaction. If Jane Smith is purchasing a car by making a wire transfer to Frank Jones, both Jane Smith and Frank Jones are parties.

A transaction may be any interaction, e.g., initiated by a customer of a financial institution, between the customer and the financial institution, and may potentially involve other parties, for example, wire transfer. Some transactions may involve transfer of funds, updating a customer's records, e.g. address change, or any other banking activities such as ordering checkbooks, requesting statements and the like.

When used herein, the term “channel” may refer to any pathway used to convey information from one computing system to a second computing system, e.g., from a transmitter to a receiver. It will be understood that embodiments of the present invention may be implemented over secure channels as well as non-secure channels.

Embodiments of the present invention are directed to system and method for improving accuracy of a risk scoring system, for example, a transactional fraud risk scoring system, leading to higher fraud detection rates and/or lower fraud false positive rates. Embodiments of the present invention may allow leveraging or using information that is publicly available on a public network, e.g., on social media sites or channels, and allow, an institution or an organization, e.g., a financial institution, to better assess the nature of fraudulent and legitimate actions or transactions of users, customers or clients in order to effectively identify events of interest, for example fraudulent events.

Embodiments of the invention may present a framework for gathering or retrieving or accepting information from social media sources, e.g., Facebook, LinkedIn, Twitter, etc., comparing, correlating or matching this information to known entities, e.g., users or customers within a business environment, for example, a financial institution and to transactions associated with these entities, and leveraging the information to assess a fraud risk associated with these transactions. The information gathered from social media sources regarding a party to or associated with a transaction, who is believed to be a user of business environment, may be compared to the information related to that user which already exists in the business environment. If all or some details gathered from the social media sources, for example, full name, address, telephone number, and/or other personal details are identical to the details of the party of or associated with the transaction, then a transaction may be determined to be less suspicious.

For example, a suspicious transaction of money transfer may be less suspicious if the recipient's name is listed as a contact or a friend of the originator on a social network such as Facebook or Linkedin. Another suspicious transfer may be less suspicious if both parties belong to related business segments or share professional affiliations on social network such as Facebook or Linkedin. A transaction made from a high-risk country may be less suspicious if the initiator has recently announced via a social networking site that he is travelling to the same country or “checked in” to a social network from that country. A transfer to a high-risk country is less suspicious if the initiator has contacts or friends in that country, or if the initiator has a prior address in that country. An address change event may be less suspicious if the initiator has recently updated the same address online, or announced moving to a new address on a social network.

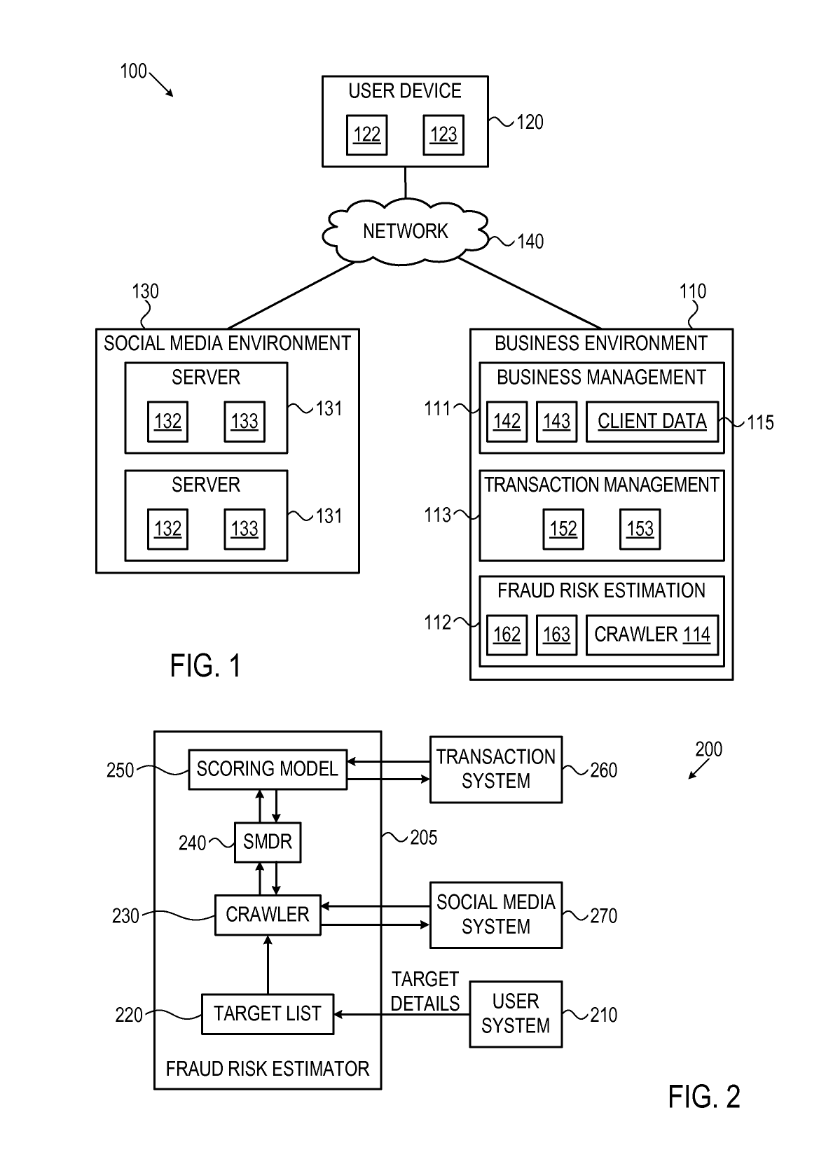

Reference is now made to FIG. 1, which is a high-level block diagram of a fraud risk estimation system according to embodiments of the present invention. Fraud risk estimation system 100 may include one or more user devices 120. Customers or users may operate user devices 120 to interact over one or more communication channels via one or more networks 140, e.g. such as the Internet or telephone networks. User devices 120 may include any end device such as, for example, smart mobile devices and wireless computers such as smartphones, tablet devices or computers, computers for web or Internet connections, telephones for telephone or radio network connections, messaging or text enabled devices for messaging network connections or any other end device. User devices 120 may connect via network 140 to a social media environment 130 and to a business environment 110.

Business environment 110 may be a company, business, institution or corporation, for example, a financial institution such as a bank, an online retailer or any other company, firm, business or corporation. Business environment 110 may include or operate units such as a business management system 111, a transaction management system 113 and a fraud risk estimator 112. It should be understood that each of fraud risk estimator 112, transaction management system 113 and/or business management system 111 may be hosted by different servers and/or located in different locations. For example, business environment 110 may be hosted or operated by an entity or system, other than the company itself, which may provide support for the company and interact with customers on the company's behalf, for example, a bank may use an external transaction system which may process currency transfers to/from bank clients.

Transaction management system 113 may perform, process and control one or more transactions on behalf of the company and a user or customer. For example, transaction management system 113 may transfer or cause to be transferred money from a bank account of the customer to a bank account of a third party (which may be considered associated with the transaction). Business management system 111 may include all data and information known to the company, for example, all information related to users, clients or customers of the company. Fraud risk estimator 112 may receive information related to a transaction from transaction management system 113, information related to users of the company from business management system 111 and information from social media environment 130 in order to determine, calculate or estimate a fraud risk related to a certain transaction.

Fraud risk estimator 112 may retrieve or accept social media information related to customers or users from social media environment 130 via or from network 140. Social media information may include details and data related to a person, for example, first name, family name, telephone number, address, work details, date of birth or any other personal related details. Social media information may include information about relations (such as being “friends”, being “connected”, belonging to the same interest or other group, etc.) between a first person to other persons, companies, places and the like. Fraud risk estimator 112 may receive information related to a transaction from transaction management system 113 as well as information related to a party participating in or associated with the transaction (e.g., a party to the transaction). Fraud risk estimator 112 may correlate or match the received information to the party, entity or a customer performing the transaction, may calculate a risk score and determine, calculate or estimate a fraud risk, associated with the transaction, based on the comparison or correlation between the social media information and the information related to the transaction.

Social media environment 130 may include one or more social media servers 131. In social media environment 130, users may interact via user device 120, over a social media platform provided by social media servers 131. Social media servers 131 may provide any type of social media technology or social networking service including, for example, web-logs (blogs), video blogs, micro-blogs, wilds, podcasts, instant messages, automatic notifications, exchange of social media information, definition of relationships (e.g. “friend”, “family”, “connection”) among various social media users, etc. Social media servers 131 may be operated by providers such as, Facebook, Twitter, Wikipedia, YouTube, etc. Users of social media environment 130, for example, users, using user devices 120, may update their personal profile details, write social media posts, exchange messages, establish or define relationships with other social media users, including automatic notifications when they update their profile and may perform any operation available, required or provided by social media environment 130. Some of the information shared in social media environment 130 by a certain user may be unique and distinct from information provided by the same user in business environment 110 while other information shared in social media environment 130 by the certain user may be identical to information provided by that same user in business environment 110.

When used herein, “social media information” may refer to any data, information, detail, item, and/or entry of content identifying, associated with, or entered by or posted by, a person over a social media channel, website and/or network. Social media information may be gathered and/or retrieved from personal details, posts of text or images, memberships or affiliations in groups and the like in a social media channel, website and/or network. For example, such information may include first name, family name, telephone number, address, work details, date of birth or any other personal related details, locations visited, people associated with or “friended”, etc.

When used herein, “customers” of the company may be registered in or connect to business environment 110 while being registered in social media environment 130 as “users” of social media. Embodiments of the invention may link, pair or match customers of business environment 110 to social media users of social media environment 130. When used herein, a “target” may be used to indicate a certain customer of business environment 110 that may be linked to a user of social media environment 130. Information may be searched for relating to a target, and if a party to a transaction matches or is the same person as the target, the social media information for the target may be associated with the party.

Business management system 111 may include a client database 115 which may include non-transactional information of clients such as home address, name, and work history related to customers of the company. Such non-transactional information may be provided to the company by the customer, e.g., when opening a bank account.

Fraud risk estimator 112 may include a data crawler 114 which may obtain information related to users of social media environment 130. Data crawler 114 may search for interactions, statuses and profiles in social media environment 130 and may probe blogs, forums and web sites hosted by social media servers 131. Data crawler 114 may use social media APIs e.g., specific to each social media host or server 131 or link to a third party data compiler or web crawler. Data crawler 114 may use any suitable type of search filter to identify and extract information retrieved or accepted from social media environment 130 based on any suitable criteria. Fraud risk estimator 112 may calculate a risk score of a transaction based on the correlation, comparison, resemblances or similarity between the social media information gathered by data crawler 114 and the transactional information, e.g., beneficiaries, geographic location (e.g. location of a party such as a bank) and transaction currency from transaction management system 113 as well as the non-transactional information from client data base 115 of business management system 111 to determine, calculate or estimate a fraud risk related to a certain transaction.

Embodiments of the invention may use publicly available information on social media sites received from social media environment 130 to build profiles on customers, beneficiaries etc. with information that can augment the risk scoring of events, mainly by providing plausible explanations for otherwise suspicious activity. For example, a suspicious transaction of money transfer may be less suspicious if there is a correlation or a match between the recipient name and one of the originator's contacts, namely, if the name of the recipient is included in the social media information gathered for the transaction originator, e.g., if the recipient's name is listed as a contact or a friend of the originator on a social network such as Facebook or Linkedin the transaction may receive a low risk score. Another suspicious transfer may be less suspicious and may receive a low risk score if the social media information of both parties include data indicating that both the originator and the recipient belong to related business segments or share professional affiliations on social network such as Facebook or Linkedin. Other examples, may include a transaction made from a high-risk country which may receive a low risk score and be less suspicious if the social media information include details about presence of the originator in that country, e.g., the originator has recently announced via a social networking site that he is travelling to the same country or “checked in” to a social network from that country. A transfer to a high-risk country receive a low risk score and be less suspicious if the social media information indicates that the originator has a relation to that country, for example, if the originator has contacts or friends in that country, or if the originator has a prior address in that country—in such a case there may be a relation, or a positive relation, between the social media information and the transaction information. An address change event may be less suspicious if the initiator has recently updated the same address online, or announced moving to a new address on a social network.

Embodiments of the invention may provide an analysis of social media information to assess whether individual transactions are likely to have been initiated by a legitimate customer to allow high detection rates and/or low false positive rates within multiple risk scoring products, especially fraud detection products.

User device 120, social media servers 131, business management 111, fraud risk estimator 112 and transaction management 113 may each include or be one or more controller(s) or processor(s) 132, 122, 142, 152 and 162, respectively, for executing operations and one or more memory unit(s) 133, 123, 143, 153 and 163, respectively, for storing data and/or instructions (e.g., software) executable by a processor. Processor(s) 132, 122, 142, 152 and 162 may include, for example, a central processing unit (CPU), a digital signal processor (DSP), a microprocessor, a controller, a chip, a microchip, an integrated circuit (IC), or any other suitable multi-purpose or specific processor or controller. Processor(s) 132, 122, 142, 152 and 162 may include or execute in conjunction with one or more operating systems which may be or may include any code segment designed and/or configured to perform tasks involving coordination, scheduling, arbitration, supervising, controlling or otherwise managing operation of interaction analytics 120, for example, scheduling execution of programs. Memory unit(s) 133, 123, 143, 153 and 163 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units. Memory unit(s) 133, 123, 143, 153 and 163 may be or may include a plurality of, possibly different memory units and may include executable code, e.g., an application, software, a program, a process, task or script. The executable code may be executed by processor(s) 132, 122, 142, 152 and 162, respectively, possibly under control of an operating system.

User device 120 may include one or more input devices, for receiving input from a user or agent (e.g., via a pointing device, click-wheel or mouse, keys, touch screen, recorder/microphone, other input components) and output devices (e.g., a monitor, display, speaker or screen) for displaying data to a user/customer and agent, respectively. User device 120, social media servers 131, fraud risk estimator 112, business management 111 and transaction management 113 may each be or include, for example, software executed on one or more processors (e.g., one or more of processor 132, 122, 142, 152 and 162), and while this software may be in one processing device or server, it is not necessarily executed by the same processor or within the same computing device. Methods disclosed herein may be executed on one or more processors (e.g., one or more of processor 132, 122, 142, 152 and 162.

Reference is now made to FIG. 2, which is a schematic illustration of a fraud risk estimation system according to embodiments of the present invention. Fraud risk estimation system 200 may be implemented by elements of, for example, fraud risk estimator 112, business management 111, transaction management 113 and social media environment 130 of FIG. 1.

Fraud risk estimation system 200 may include a user system 210, a fraud risk estimator 112, a social media system 270 and transaction system 260. User system 210 may include information of users or clients of the company which may be saved for example, in client database 115 of FIG. 1, and may transfer such information to fraud risk estimator 112. Fraud risk estimator 112 may include a target list module 220, a crawler 230, a social media data repository (SMDR) 240, e.g., memory 163 and a scoring model 250. Fraud risk estimator 112 may receive information regarding a transaction from transaction system, e.g., transaction management 113 of FIG. 1, and information related to users of a transactional system performing the transaction, from user system 210. Fraud risk estimator 112 may retrieve or accept social media data or social media information related to one or more parties of the transaction from social media system 270, e.g., social media server 131 of FIG. 1 and may determine, calculate or estimate a fraud risk related to the transaction as described in embodiments of the invention. The functions of fraud risk estimator 112 may be for example carried out by a processor such as processor 162 executing code or instructions stored in for example memory 163.

According to embodiments of the invention, target list module 220 may include a list of targets or entities of interest, for example, people, parties or clients for which social media data may be collected, gathered or retrieved. If a party to a transaction matches or is the same person as the target, the social media information for the target may be associated with the party. For example, when using system 200 as part of a bank's fraud detection solution, target list module 220 may include all bank customers. The list of targets from target list 220 may be an input to crawler 230, for example, crawler 114 of FIG. 1. Crawler 230 may periodically access social media system 270, e.g., social media server 131 of FIG. 1 and retrieve social media information related to each of the targets or entities in target list 220. The retrieved data information may be stored in SMDR 240 (information may be stored elsewhere). SMDR 240 may store all data or information retrieved relating to targets or entities in target list 220 and may update the data for each of the entities upon any change detected upon probing social media system 270. The updated information may be transferred to scoring model 250 which may use the relevant information to assign a risk score to transactions handled by a transaction system 260, e.g., transaction management system 113 of FIG. 1.

According to embodiments of the invention, target list module 220 may include a list of targets; each entry in the list may include a plurality of fields that may identify a certain target, for example a certain client or customer of user system 210. Although embodiments of the invention are not limited in this respect, each entry in the target list may include a plurality of fields, for example, a target identification (ID), an entity ID and one or more social media IDs. Other or different fields than the examples given here may be used. Target ID may be, for example, a number, uniquely identifying each list entry which may be generated automatically by user system 210. Entity ID may be a string, number, or other data identifying the entity referenced by the list entry e.g. a specific bank customer. The entity ID may be used to correlate social media data stored in SMDR 240 with transactional data from external systems, e.g., from transaction system 260. For example, when a bank customer, considered a target, executes a financial transaction by transaction system 260, scoring model 250 may extract the customer's entity ID from the transaction data, and may use it to query SMDR 240 for any social media data related to that customer from social media system 270.

Each of the one or more social media IDs may identify a certain social media system and a user of the social media system and may include one or more fields, for example a social media system ID field and a social media user ID field. Social media system ID field may include a unique identification of one of a predefined set of known social media systems. For example, a social media system ID “1” may indicate Facebook, a social media system ID “2” may indicate LinkedIn, etc. Any other social media system may be used. Social media user ID field may include a unique identification of a user within the social media system identified by social media system ID field. For example, if social media system ID “1” indicates Facebook, the social media user ID may be a Facebook user identification belonging to the entity referenced by a target list entry. It should be understood to a person skilled in the art that a single target from the target list may have multiple user IDs associated with the same social media system and/or with different social media systems. For example, the same customer may have multiple Facebook user IDs, as well as LinkedIn user IDs.

According to some embodiments of the invention, system user 210 may create, for example by a human operator or by an automated system, a new entry in target list 220. For example, a standard user interface such as a web user interface or a standard API such as a Java interface, a SOAP protocol (a protocol specification for exchanging structured information in the implementation of Web Services in computer networks) web service and the like may be used. User system 210 may provide an entity ID and one or more pairs of social media system IDs and social media user IDs via, for example, a user interface or API. Target list module 220 may assign a new target ID to the target and may store the information provided in a persistent storage such as a database, memory or other storage unit associated with fraud risk estimator 112.

Operation of editing a target in target list 220 may be performed by system user 210 which may locate an existing entry in target list 220, for example, through a user interface, such as a web user interface or through a standard API, e.g., a Java interface, a SOAP web service, and the like. A search for existing entries in target list 220 may be based on a given entity ID, or other details stored in target list 220. The stored data for an entry may be edited or removed by a user or by an automatic operation and the updated information may be stored in target list 220.

An exemplary usage of fraud risk estimation system 200, may include an external user system such as a bank's customer record management system that may add new targets to the target list automatically whenever a customer provides a new social media user ID to the bank through any banking channel, e.g., a branch, a telephone, web site, etc.

In some embodiments, a new entry in target list 220 may be created, without knowing the target's social media user ID, while in other embodiments, a target's social media user ID for one social media system may be known, while its social media user ID for other social media systems may be unknown. In both scenarios, fraud risk estimation system 200 may attempt to automatically identify the target's social media user ID in one or more social media systems 270, by comparing other known details about the entity to available social media information. For example, the fraud risk estimator 112 may detect a strong similarity between a bank customer's personal details that are known to the bank, to the personal details of an unidentified person that are published on a social media system. Exemplary personal details may include first name, family name, telephone number, address, work details, date of birth or any other personal related details. In such a case, fraud risk estimator 112 may determine that the unidentified person is, with high likelihood, the same person as the bank customer, e.g., the target, and may determine the bank customer's social media user ID through this connection.

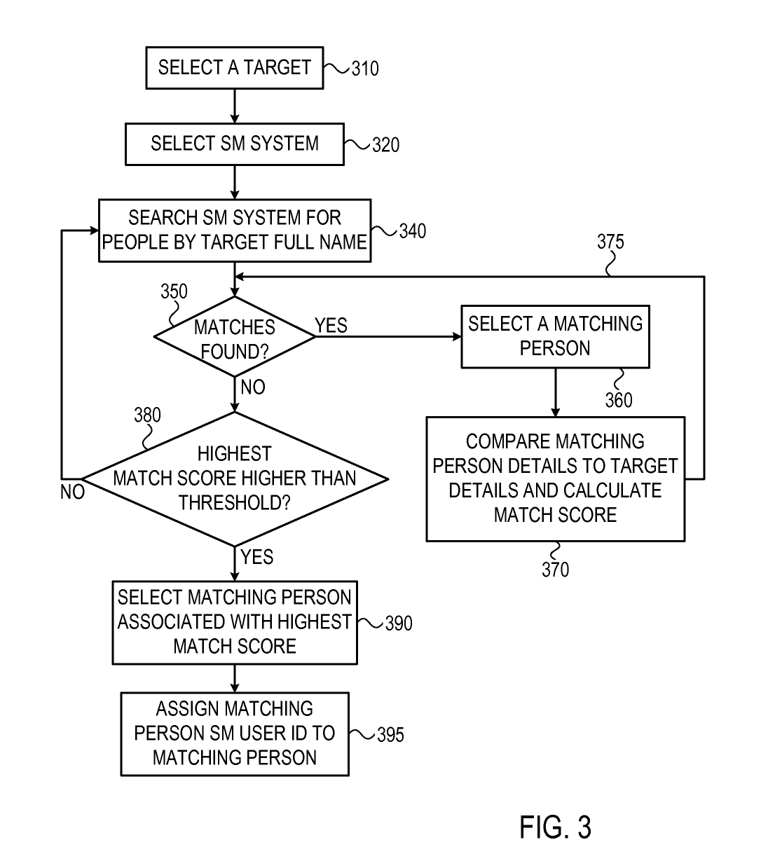

Reference is now made to FIG. 3, which is a flowchart of a target association process according to embodiments of the present invention. Target association may include creating an association or link between a target and social media identification of the target; e.g., the name or public name of a person when using a certain social media site may be determined. People may have different names, name spellings or aliases when using social media information, and embodiments of the invention may match a person's name as known to a fraud detection system with the name as used on social media systems. Operations of the method may be implemented, for example, by one or more of the elements in FIG. 2, for example, fraud risk estimator 112 and/or by other suitable units, devices, and/or systems

According to embodiments of the invention, social media information may be gathered for all entries in the target list. However in some embodiments, the social media user ID of a target may be unknown while in other embodiments a target's social media user ID for one social media system may be known, while its social media user ID for other social media systems may be unknown. The target association process described in FIG. 3 may be performed by fraud risk estimation system 200 in order to automatically identify a target's social media user ID in one or more social media systems in order to allow gathering social media information for every target in the target list, e.g., before a target is identified as a party to a transaction.

As indicated at box 310, the method may include selecting a target requiring correlation, detection, auto-detection, or association with social media user ID, e.g., selecting a certain customer of business environment 110 of FIG. 1 which may have a target list entry that needs to be matched, correlated or linked with users of social media environment 130 of FIG. 1. A target may be selected upon adding a new target in target list 220, e.g., a target that may be added without a social media user ID or periodically at predetermined times.

As indicated at box 320, the method may include selecting a social media system from a predefined list of social media systems such as, for example, Facebook, LinkedIn, and the like. It should be understood to a person skilled in the art that embodiments of the invention may include iterating over all known social media systems from a predefined list. The predefined list of known social media systems may be updated by adding names of social media systems.

As indicated at box 340, the method may include searching or probing e.g., by crawler 230 of FIG. 2, the selected social media system for people having a full name identical to the full name of the selected target.

As indicated at box 350, the method may include checking if a match between full name according to target information and full name within social media information is found.

As indicated at box 360, the method may include selecting a matching person which his full name as appeared in the social media data is identical to a full name of a target from the target list.

According to embodiments of the invention, known name and/or entity matching technologies may be used to determine a match score reflecting the likelihood that a person or users found in the social media data is/are the same person as the target. An exemplary algorithm is described in “A Comparison and Analysis of Name Matching Algorithms” by Chakkrit Snae, World Academy of Science, Engineering and Technology 25 2007.

As indicated at box 370, the method may include comparing available details for social media users to the available target details, e.g., comparing other details, information or data appeared in social media system and related to the matching person to other details, information or data related to the target, for example, comparing address, gender, telephone number, work details, date of birth or any other information. The method may further include calculating a match score using all related details or information found. The match score may reflect the likelihood that a person or user found in the social media data is the same person as the target. The match score calculating may be performed for every match found as indicated by arrow 375.

As indicated at box 380, after a match score is calculated for each of the matches found in the social media, the method may include checking if the highest match score found is greater than a predefined threshold. In some embodiments, if the highest match score found is lower than a predefined threshold, the method may include performing another iteration of searching social media systems for people with identical full name while reducing the predefined threshold, in other embodiments the method may select the matching person with the highest match score. If no match score was found above the threshold, the method may include repeating the process periodically, e.g. once a day, once a week or non-periodically.

As indicated at box 390, the method may include selecting the person associated with the highest match score and assigning or associating the social media user ID related to a person associated with the highest match score to the target as indicated at box 395.

According to embodiments of the invention, the target association process described by FIG. 3 may create a link or association between each target of target list 220 and social media user ID which may allow retrieving social media information related to that target from social media system.

It should be understood to a person skilled in the art that other operations or sets of operations may be used in accordance with embodiments of the invention.

Reference is made back to FIG. 2, according to embodiments of the invention, crawler 230 may be implemented by, for example, a software component (for example, executed by processor 162) that may periodically access social media systems 270 and may retrieve recent data for entities on target list 220. Crawler 230 may retrieve data from a predefined list of known social media systems 270, and may retrieve available public information related to each target entity of target list 220 based on the target's social media user ID. Crawler 230 may retrieve, for each target based on the social media user ID, social media information related to a target, such as, for example, personal identifying details, contact information and recent changes to it, location information, related people information and the like.

Exemplary social media personal identifying details may include, for example, full name, employer name, date of birth and the like. Exemplary contact information may include, for example, current address(es), e-mail address(es), telephone number(s) and the like. Exemplary social media location information may include, for example, countries, addresses and other locations mentioned such as, birth location, current and prior residence locations, current and prior employment locations, “check in” locations, namely, semi-structured posted information whereby the target announces that they are at a certain location, locations mentioned in other structured or semi-structured posts such as TripIt updates, location information and/or geo tagging in posted images or other posted media and locations mentioned in unstructured textual posts, that may be identified by Natural Language Processing (NLP) methods, and the like. Exemplary social media related people information may include, for example, full names and social media user IDs of related people. “Related” people, people related via a social media system, or people having a “social media relationship” or may include, e.g., “friends” (e.g., people who are friends on Facebook), “connections” (e.g., people who are connected on LinkedIn). Related people may include people who share social media group membership which may include, for example, groups, forums, pages and distribution lists according to information available in social media systems. Other information related to a target may be retrieved. Crawler 230 may also retrieve some or all of the information listed above for people who are found to be related to targets, and are not targets themselves, e.g., people listed as “friends” or “connection” to a target.

According to some embodiments, for social media systems that are Internet websites, for example Facebook, LinkedIn, and Twitter, the crawler 230 may be designed using web crawler technology. An exemplary design of a crawler is described in the U.S. patent application Ser. No. 13/409,514, filed Mar. 1, 2012 incorporated herein by reference.

Crawler 230 may store retrieved information in for example SMDR 240, e.g., memory 163 (information may be stored elsewhere). Information about targets may be stored in the SMDR under an entity ID taken from the target list, using for example each target's corresponding entity ID from the target list. Information about non-targets, for example, information for people who are found to be related to targets, may be stored using an entity ID that may be created by crawler 230 as a composition of the social media system ID and some reasonably unique and stable ID of the entity within the specific social media system. This ID may be the social media user ID if it is known, or another value. For example, the composition of the social media system ID, a person's full name and birth date may constitute a reasonably unique and stable entity ID for a non-target.

According to embodiments of the invention, SMDR 240 may be implemented by a software and/or hardware component, e.g., memory 163, and may store recent and/or historic data of interest from social media systems 270 about targets. Data stored may primarily arranged by entity or target, such that data for a specific entity may be located quickly if the entity ID is known. Additionally or alternatively, data may be arranged by an update date, such that the most recent data may be first available, and prior data for the same fields may also be available. For example, if a person changed the e-mail address published on their public social media profile, and this profile was retrieved by crawler 230, both before and after the change, SMDR 240 may store both the old and new e-mail addresses along with the date when each one was retrieved.

SMDR 240 may store for each entity or target social media data, such as, for example, personal identifying details, contact information, location information, social media group membership, information of related people and the like. Information of related people such as entity IDs of related people may be collected through subsequent queries, which may allow retrieving any social media data that was collected for the related people and stored as separate entities in SMDR 240, e.g. their full names, addresses, etc.

According to some embodiments of the invention, crawler 230 may provide new information from social media systems 270 about a new or existing entity according to a request from user system 210. The crawler 230 may provide an entity ID, an update date (e.g. the date when the data was last retrieved from the social media systems 270), and any new social media data that may be available. SMDR 240 may check if an entity with the same entity ID already exists, and may create a new entity if not. SMDR 240 may update the persistently stored data for the entity with the new social media data. Any social media data that may be already stored for the entity is retained, e.g., is not overwritten. SMDR 240 may index the data by entity ID and may update date using any indexing technologies, for example a relational database management system (RDBMS) index.

According to some embodiments of the invention, scoring model 250 may retrieve available data for a specific entity upon an event received from transaction system 260. Transaction system 260 may provide an entity ID, and SMDR 240 may check if an entity with the provided entity ID already exists. If not, SMDR 240 may return an appropriate response to the scoring model or directly to transaction system 260. In other embodiments, SMDR 240 may retrieve from the persistent storage all available social media data for the specified entity, and send it as a response to transaction system 260.

According to embodiments of the invention, scoring model 250 may be implemented by a software and/or hardware component (e.g., processor 162) that may calculate risk score to a transaction in real-time or in batch such that a higher risk score may indicate a higher likelihood of a transaction being fraudulent. Scoring model 250 may extract known entity IDs from transaction system 260, e.g., the party initiating the transaction, e.g., the beneficiary of a payment transaction, and other involved parties where applicable and may query SMDR 240 for any available social media data associated with them. Although the invention is not limited in this respect, in order to achieve a useful level of predictive accuracy, scoring model 250 may be combined with additional scoring models (not shown), to form a complete risk scoring system. For example, the risk score calculated by scoring model 250 may be used as an input variable to other scoring models, for example, to a logistic regression model, a simulated neural network model, a rule-based model, or other model to determine a final risk score.

Scoring model 250 may determine a risk score of a given transaction by calculating key indicator values from the transaction details and calculating a risk score based on the key indicator values. Scoring model 250 may include one or more key indicator functions which may receive a transaction as input and may return one or more key indicator value as output. Key indicator values may describe, define or express a relation between two or more persons, entities or parties to a transaction. For example, applying a key indicator function that checks relation between an originator and a beneficiary of a transaction may output key indicator values such as, “no relation”, “weak relation”, “strong relation”, a related numerical rating, and the like (both the originator and beneficiary may be considered parties associated with the transaction). Each key indicator function may be associated with a predefined set of possible output values, or a discrete set of outputs. Each of the output values may indicate a different level of transaction risk.

According to embodiments of the invention, scoring model 250 may receive a transaction, extract details from the transaction, e.g., entity ID and apply one or more key indicator functions to receive key indicator values and calculate a risk score related to a transaction based on the key indicator values by applying a logistic regression model. The logistic regression model may receive the key indicator output values as input variables and may output a risk score. A logistic regression model may use to predict an outcome of a categorical criterion variable, e.g., a variable that may take a limited number of categories, based on one or more predictor variables. The probabilities describing the possible outcome may be modeled, using a logistic function. The regression model may be tuned or “fitted” in advance using the key indicator values calculated for a large set of known fraudulent and non-fraudulent transactions.

Some embodiment of the invention may include transactions having more than one party, e.g., two parties. Social media information for each party may be gathered independently for each party and if a relation between the two parties is identified between the two parties, the transaction may be less suspicious. Identifying a relation between the two parties may include identifying a relation between social media information related to the first party and social media information related to the second party.

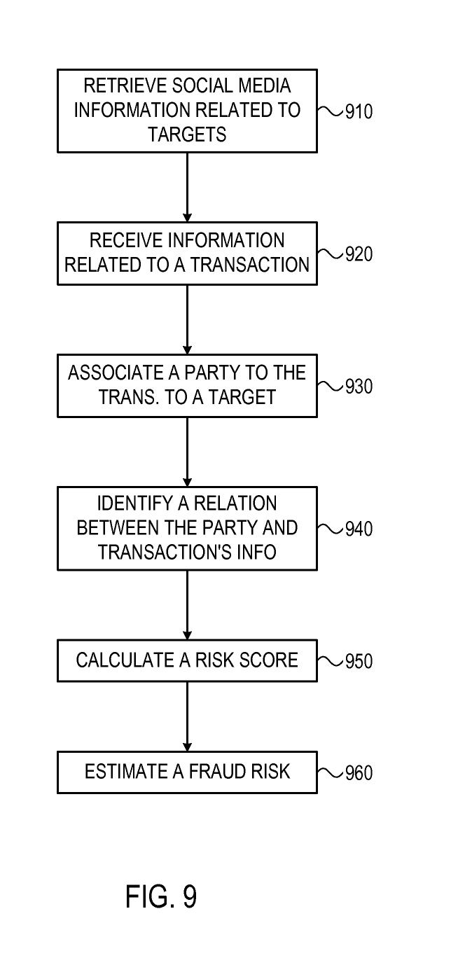

Reference is now made to FIG. 9, which is a flowchart of a method for fraud risk estimation according to embodiments of the present invention. Operations of the method may be implemented, for example, by one or more of the elements in FIG. 2, for example, fraud risk estimator 112 and/or by other suitable units, devices, and/or systems.

As indicated at box 910, the method may include retrieving social media information related to targets from target list 220, for example by using the social media ID. The targets may be users, customers or persons related to an organization, company or institution, for example, a financial institution. According to embodiments of the invention each target from target list may have a social media ID. The social media ID may be obtained for example by receiving it from the target, e.g., a user who opens an account may give his or her social media ID as part of identification, or by applying an association process for example described in FIG. 3. Social media information may be gathered for all entries in the target list and may be saved in a dedicated database, such as SMDR 230. Crawler 230 may search (e.g., on remote social media websites accessible via the Internet) for social media information related to a target based on a social media identification of the target. After associating or determining a link between a target and a social media identification of the target crawler 230 may store the social media information related to the target in a dedicated storage, database or memory, e.g. SMDR 230. An association process may include, for example, comparing address, gender, telephone number, work details, date of birth or any other information and calculating a match score using all related details or information found, the match score may reflect the likelihood that a person or users found in or associated with the social media data is the same person as the target.

As indicated at box 920, the method may include receiving information related to a transaction, e.g., a financial transaction. The information may be received from a transactional system associated with the company, or institution having a target or customer list, e.g., target list 220. In other embodiments, a target list need not be used, and/or social media information regarding the party need not be known to the system before the transaction is initiated or takes place. The information related to a transaction may include information related to a party to the transaction such as, a full name, address, gender, telephone number, family members, friends and the like. The information related to a transaction may include information related to a location of the transaction such as, the address or location from which the transaction may take place, the address or location to which the transfer is being made, the address or location of financial institutions involved, and the like. A location, or a geographic location, may include or be an address.

As indicated at box 930, the method may include associating or determining a link or equivalency between a party to the transaction and a target based on one or more identical details, e.g., full name, address, social media ID, telephone number and the like. After an association is made the information regarding the target including the social media information previously retrieved from social media from social media servers may be used to ensure the safety of the transaction and estimate the fraud risk of the transaction.

As indicated at box 940, the method may include identifying a relation or correlation between the social media information related to the party and the information related to the transaction. A relation, or a positive relation, may be some connection between or among parties to the transaction, or between information about a party to a transaction and information regarding the transaction. A positive relation may be indicative that the transaction is legitimate. For example, a relation between the current location, residence, etc. of a party, or a location associated with a party, as indicated by social media data (e.g., a Facebook post indicating the party is visiting Spain), if compared to a financial transaction involving Spain, may indicate a transaction is legitimate. A relation between two parties may exist because each party, as indicated by social media data, belong to the same on-line or other social organization; such a relation if compared to a financial transaction indicating one of the parties is transferring money to the other, may indicate a transaction is legitimate. Similarly, if social media information indicates that a party to a transaction has no link to a location, person, or other data in a transaction, it may cause a risk score to be increased for that transaction.

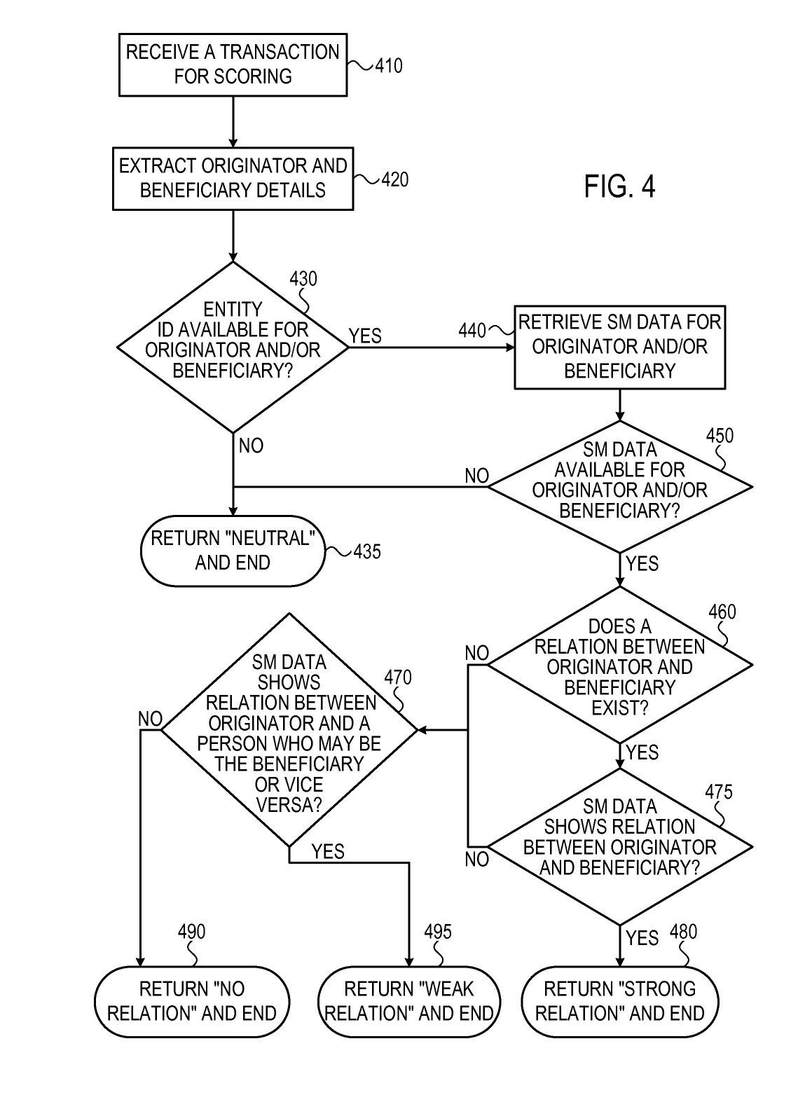

For example details may be extracted related to or describing parties to a transaction from the transaction details and a similarity may be searched for between the social media information related to the party and the information related to the transaction. In some embodiments, determining the relation may be performed by applying one or more predefined functions, also refereed to herein as “key indicator functions” which are described with reference to FIGS. 4-8. Predefined functions, or key indicators, need not be used. Each of the key indicator functions may in some embodiments output one or more key indicator outputs chosen from a predefined set of possible output values, or discrete outputs. The key indicator outputs may express, define or identify a relation between a target and transaction information. For example, the key indicator outputs may include the outputs “no relation”, “weak relation”, “strong relation” (possibly expressed as a number) that identify the relation between two parties to the transaction. Other key indicator outputs may include the outputs “no related location”, “indirectly related location” and “related location” that identify the relation between a party to a transaction and a certain location related to a party to the transaction. Each key indicator function may be associated with a predefined set of possible output values and each of the output values may indicate a different level of transaction risk.

As indicated at box 950, the method may include calculating a risk score, associated with the transaction, based on the relation identified by the key indicator outputs. The calculation of the risk score may be performed by applying one or more regression models on the key indicator outputs to receive the risk score. A logistic regression model may use to predict an outcome of a categorical criterion variable, e.g., a variable that may take a limited number of categories, based on one or more predictor variables. The probabilities describing the possible outcome may be modeled, using a logistic function. The regression model may be tuned or “fitted” in advance using the key indicator values calculated for a large set of known fraudulent and non-fraudulent transaction.

As indicated at box 960, the method may include estimating a fraud risk, associated with the transaction, based on the risk score. For example, a high risk score may indicate a high fraud risk.

It should be understood to a person skilled in the art that other operations or sets of operations may be used in accordance with embodiments of the invention.

Reference is now made to FIG. 4, which is a flowchart of an exemplary key indicator function according to embodiments of the present invention. Such a function may in some cases be used for or be used to determine or derive, a relation between information describing a transaction and social media information. Operations of the method may be implemented, for example, by one or more of the elements in FIG. 2, for example, fraud risk estimator 112 and/or by other suitable units, devices, and/or systems.

As indicated at box 410, the key indicator function may include receiving a transaction for scoring (e.g., receiving data related to or describing the transaction). For example, according to embodiments of the invention, a transaction processing system, e.g., transaction system 260 may send information regarding a monetary transfer transaction to scoring model 250 for risk scoring.

As indicated at box 420, the key indicator function may include extracting from the transaction details or information of the transaction originator and the transaction beneficiary (e.g., two parties to the transaction) according to data availability and the specific transfer type, e.g. wire transfer, interbank transfer, intrabank transfer and the like. While in one example parties to a transaction may include an originator and a beneficiary, in other examples, other parties may be included. The details or information extracted may include, for example, entity ID for either or both sides or parties (while “both” is used here one or more than two parties may be part of a transaction), and/or other potentially identifying details such as full name, address, and/or telephone number, for either or both sides. Extraction of the details may be performed by, for example, scoring model 250. According to some embodiments, extracting details related to one or more parties of the transaction may include extracting details from information related to users of a company from a business management system, e.g., business management system 111 of FIG. 1. Transaction details or information may include details related to the parties of the transaction, the financial or other institutions involved, the geographic locations of the parties or the institutions, the types of currencies involved, the amounts of currencies, or other details.

As indicated at box 430, the key indicator function may include checking if an entity ID is available for the originator and/or beneficiary. If an entity ID is available for the originator and/or beneficiary, the key indicator function may include querying for example the SMDR, e.g., SMDR 240, by scoring model, e.g., scoring model 250, and retrieving social media data related to the originator and/or beneficiary of the transaction as indicated at box 440. If no entity ID is available for originator and/or beneficiary, the key indicator function may include returning a “neutral” output value, indicating that no information may be determined regarding the transaction's risk and may end the function process as indicated at box 435.

As indicated at box 450, the function may include checking if social media data is available for originator and/or beneficiary, if no social media data is available for originator and/or beneficiary, the key indicator function may include returning a “neutral” output value, indicating that no information may be determined regarding the transaction's risk and may end the function process as indicated at box 435.

As indicated at box 460, if social media data is available for originator and/or beneficiary, the function may include analyzing the available social media data and looking for a social media relation between the originator and the beneficiary by, for example, scoring model 250. A social media relation may be, for example, family relation, “friends”, professional linked, and the like

As indicated at box 475, if social media data is available for both the originator and the beneficiary, and the social media data for at least one of them indicates the other as a related person, the likelihood of a relation between the originator and the beneficiary may be very high, and the key indicator function may return a “strong relation” output value and may end the function process as indicated at box 480.

If social media data is available for a party, e.g, the originator and/or the beneficiary, and the social media data does not indicate any possible relation between them, as indicated at box 470, the key indicator function may return a “no relation” output and may end the function process as indicated at box 490. A “no relation” output may indicate an increased risk that the transaction is fraudulent, because no relation was found between the originator and beneficiary.

If social media data is available for at least one of the parties of the transaction, namely, the originator and/or the beneficiary, and that social media data indicates a relation (e.g., a social media relation) between one of the parties and a person who may be the other party, e.g., a person having identifying details, e.g. full name, address, telephone number, or a combination thereof, that may match the corresponding details available for the other party, there is some likelihood of a relation between the originator and the beneficiary, and the key indicator function may return a “weak relation” output value and may end the function process as indicated at box 495.

It should be understood to a person skilled in the art that other operations or sets of operations may be used in accordance with embodiments of the invention.

According to some other embodiments, alternately and/or additionally, an “weak relation” may be further broken down to sub cases with different output values, for example “weak relation—same full name”, “weak relation—same full name and address”, “weak relation—same last name”, and the like.

In some embodiments of the invention, known name and/or entity matching technologies may be used in order to find inexact matches, reflecting a lower likelihood that a related person is the same person as the other transaction entity. For example, the key indicator function may return additional output values such as “weak relation—similar full name”, “weak relation—similar full name and address”, or any other output values.

An exemplary matching technology which may be used with embodiments of the present invention is described in “A Comparison and Analysis of Name Matching Algorithms” by Chakkrit Snae, World Academy of Science, Engineering and Technology 25 2007 may be found in http://www.waset.org/journals/waset/v25/v25-47.pdf. Other technologies may be used.

An exemplary scenario that may describe the key indicator function of FIG. 4 may include a customer named John may send money to another customer named Jane, both John and Jane may have Facebook profiles, and John's Facebook profile shows Jane as a “friend” of John's (e.g., they have a social media relationship). The transfer may be assigned with an output value of “strong relation”, indicating low risk of fraud as John and Jane are strongly related by the social media data. If John and Jane's profiles do not publicly share their “friends”, the transfer may be assigned with a “no relation” output value, indicating a slightly increased risk of fraud.

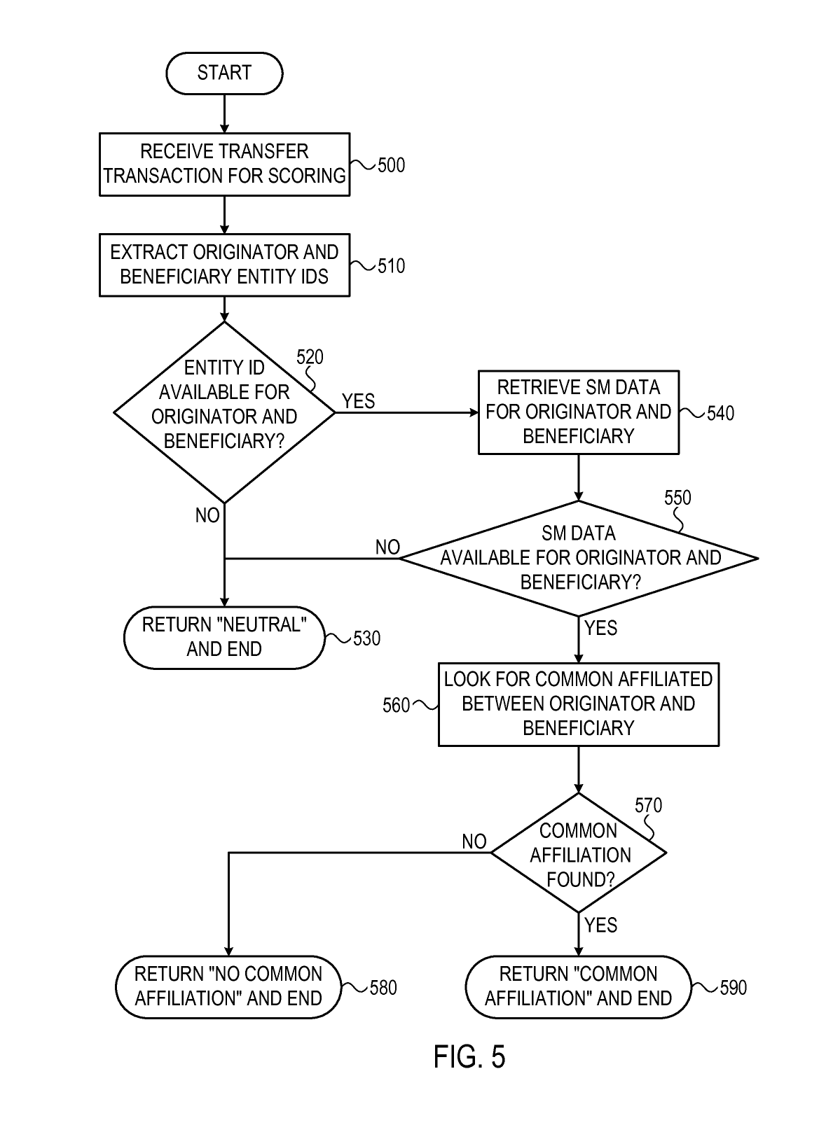

Reference is now made to FIG. 5, which is a flowchart of an exemplary key indicator function according to embodiments of the present invention. Operations of the method may be implemented, for example, by one or more of the elements in FIG. 2, for example, fraud risk estimator 112 and/or by other suitable units, devices, and/or systems.

As indicated at box 500, the key indicator function may include receiving a transaction for scoring (e.g., receiving details on or data relating to the transaction). According to embodiments of the invention, a transaction processing system, e.g., transaction system 260 may send a monetary transfer transaction (e.g., details on or data relating to the transaction) to scoring model 250 for risk scoring.

As indicated at box 510, the key indicator function may include extracting from the transaction details or information of the parties of the transaction, for example, the transaction originator and the transaction beneficiary, according to data availability and the specific transfer type, e.g. wire transfer, interbank transfer, intrabank transfer and the like. The details extracted may include, for example, entity ID for either or both sides, and/or other potentially identifying details such as full name, address, and/or telephone number, for either or both sides. Extraction of the details may be performed by, for example, scoring model 250. According to some embodiments, extracting details related to one or more parties of the transaction may include extracting details from information related to users of a company from a business management system, e.g., business management system 111 of FIG. 1.

As indicated at box 520, the key indicator function may include checking if an entity ID is available for the originator and beneficiary. If no entity ID is available for originator and beneficiary, the key indicator function may include returning a “neutral” output value, indicating that no information may be determined regarding the transaction's risk and may end the function process as indicated at box 530.

If an entity ID is available for the originator and beneficiary, the function may include querying for example the SMDR, e.g., SMDR 240, by scoring model, e.g., scoring model 250, and retrieving social media data related to the originator and/or beneficiary of the transaction as indicated at box 540.

As indicated at box 550, the function may include checking if social media data is available for originator and beneficiary. If no social media data is available for originator and beneficiary, the key indicator function may return a “neutral” output value, indicating that no information may be determined regarding the transaction's risk and may end the function process as indicated at box 530.

As indicated at box 560, if social media data is available for originator and beneficiary, the function may analyze the available social media data and looking for common affiliation between the originator and the beneficiary, or common membership in groups, by, for example, scoring model 250. Common affiliation may be identified based on professional industry segments, e.g. pharmaceuticals, finance, healthcare and/or social groups, e.g. religious, ethnic, hobby-related and the like.

As indicated at box 570, the function may include checking if common affiliation or membership between the originator and the beneficiary exist. If no common affiliation is found, the key indicator function may return a “no common affiliation” output, indicating a slightly increased risk that the transaction may be fraudulent and may end the function process as indicated at box 590.

If social media data is available for both the originator and the beneficiary, and the social media data indicates common affiliation between the originator and the beneficiary, the likelihood of a social media relation between the originator and the beneficiary may be very high, and the key indicator function may return a “common affiliation” output value and may end the function process as indicated at box 580. The “common affiliation” output may indicate a decreased risk that the transaction is fraudulent, because a common affiliation between the originator and beneficiary may exist.

According to some other embodiments, alternately and/or additionally, a “common affiliation” output may be further broken down to sub cases with different output values, based on the overall popularity of the specific common affiliation. For example, if both entities are associated with an affiliation and that affiliation is not popular, the key indicator may return an output of “common affiliation—rare”, indicating a lower risk that the transaction is fraudulent. To determine what is considered a popular versus not popular affiliation, the number of members in all known affiliations at a given point in time may be considered. For example affiliations having a number of members below the 5% percentile of all known affiliations may be considered not popular. Additional levels of popularity may be defined similarly at 10% and at any other percentiles with corresponding possible output values. If multiple common affiliations were found, the output associated with the least popular affiliation may be returned by the key indicator function.

It should be understood to a person skilled in the art that other operations or sets of operations may be used in accordance with embodiments of the invention.

An exemplary scenario that may describe the key indicator function of FIG. 5 may include a customer named John may send money to another customer named Jane, both John and Jane may have LinkedIn profiles, and the LinkedIn profiles may show that both John and Jane are members of the North Carolina Professional Golf Club. The transfer may be assigned with an output of “common affiliation, indicating low risk of fraud. If John and Jane's profiles also show that both John and Jane are members of the North Carolina Quilting Society, which has very few members, the transfer may be assigned with an output of “common affiliation—rare”, indicating a lower risk of fraud.

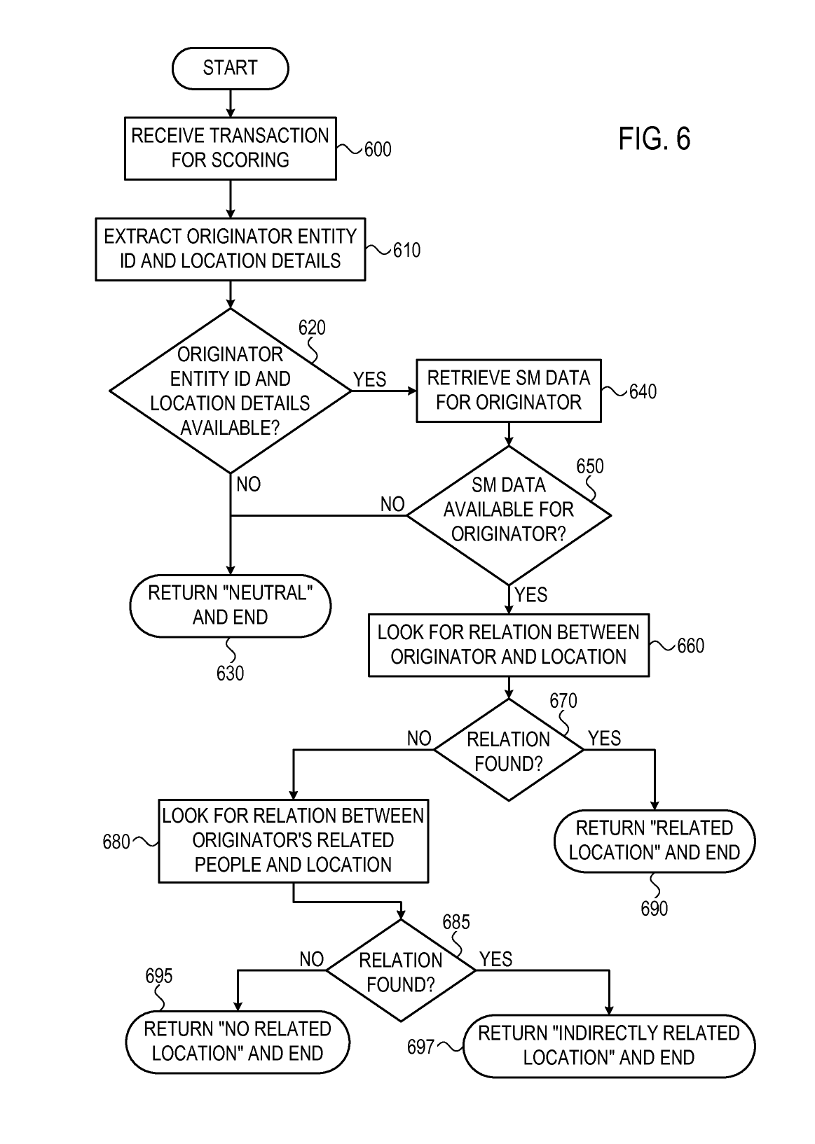

Reference is now made to FIG. 6, which is a flowchart of an exemplary key indicator function according to embodiments of the present invention. Operations of the method may be implemented, for example, by one or more of the elements in FIG. 2, for example, fraud risk estimator 112 and/or by other suitable units, devices, and/or systems.

As indicated at box 600, the key indicator function may include receiving a transaction for scoring. According to embodiments of the invention, a transaction processing system, e.g., transaction system 260 may send a monetary transfer transaction to scoring model 250 for risk scoring.

As indicated at box 610, the key indicator function may include extracting from the transaction details of the transaction originator and the transaction beneficiary according to data availability and the specific transfer type, e.g. wire transfer, interbank transfer, intrabank transfer and the like. The details extracted may include, for example, entity ID for either or both sides and geographical location details. Extraction of the details may be performed by, for example, scoring model 250. According to some embodiments, extracting details related to one or more parties of the transaction may include extracting details from information related to users of a company from a business management system, e.g., business management system 111 of FIG. 1.

Scoring model 250 may extract from the transaction information details about the geographical location of the transaction originator at the time the transaction may be set up. For example, if an originator of a transaction sets up a transaction from a physical bank branch, the extracted details may include the address of the bank branch and/or the geographical coordinates of the branch location. Another example may include a transaction that is set up through a web or mobile channel, in such a transaction, the extracted details may include estimated location of the device used to access the channel, based on session information such as, for example, source IP address. Another example may include a transaction that is set up through a telephone channel, in such a transaction, the extracted details may include the assumed location of the caller based on, for example, the area code of the caller ID. Other potentially identifying details such as full name, address, and/or telephone number, for either or both sides may be extracted.

As indicated at box 620, the key indicator function may include checking if an entity ID and location information are available for the originator and/or beneficiary. If no entity ID is available for originator and/or beneficiary or location information is not available the key indicator function may include returning a “neutral” output value, indicating that no information could be determined regarding the transaction's risk and may end the function process as indicated at box 630.

If an entity ID and location information are available for the originator and/or beneficiary, key indicator function may include querying the SMDR by scoring model, e.g., SMDR 240 and scoring model 250 and retrieving social media data related to the originator of the transaction as indicated at box 640.

As indicated at box 650, the function may include checking if social media data is available for originator, if no social media data is available for originator, the key indicator function may include returning a “neutral” output value, indicating that no information may be determined regarding the transaction's risk and may end the function process as indicated at box 630.

As indicated at box 660, if social media data is available for originator, the function may include analyzing the available social media data and looking for relation between the originator and the location information related to the transaction by, for example, scoring model 250. Any type of relation between the originator and location related to the transaction may be searched for and analyzed and, as indicated at box 670, the function may include checking if relation between the originator and the transaction's location exists.

A first example for relation between the originator and location related to the transaction may include geographically proximity to originator's address, e.g., if one of the current or prior addresses in the originator's contact information may be geographically proximate to the transaction location. A close proximity may be predefined at a certain distance, e.g. less than 100 KM, and may indicate a strong relation, while a distant proximity may be predefined at a certain distance, e.g. between 100-1,000 KM may indicate a weaker relation. In such a case, the key indicator function may return an output of “related address—close” or “related address—distant” correspondingly and may end the function process as indicated at box 690.

A second example for relation between the originator and location related to the transaction may include geographically proximity to a mentioned location, e.g., if one of the originator's recently mentioned countries, addresses and other locations is geographically proximate to the transaction location. A close proximity may be predefined at a certain distance, e.g. less than 100 KM, and may indicate a strong relation, while a more distant proximity may be predefined at a certain distance, e.g. between 100-1,000 KM may indicate a weaker relation. In this case, the key indicator function may return an output of “related location—close” or “related location—distant” correspondingly and may end the function process as indicated at box 690.

As indicated at box 680, if no relation is found between the originator and the transaction's location information, the key indicator function may include looking for relation between one or more of the originator's related people and the transaction's location information, for example, a geographically proximity of one of the originator's related people address to the transaction's location, or geographically proximity of one of the originator's related people mentioned location to the transaction's location. A relation between one or more of the originator's related people to the transaction location may indicate a weaker relation than if the originator had an equivalent direct relation to the transaction location.

As indicated at box 685, the key indicator function may include checking if relation between one or more of the originator's related people and the transaction's location exists, if no relation was found, the key indicator function may return a “no related location” output that may indicate an increased risk that the transaction is fraudulent and may end the function process, as indicated at box 695. If a relation between one or more of the originator's related people and the transaction's location exists, the key indicator function may return an output “indirectly related address” and may end the function process as indicated at box 697. According to some embodiments so the invention, the output may vary according to or based on predefined criterions of relations, for example, “indirectly related address—close” or “indirectly related address—distant” or “indirectly related location—close” or “indirectly related location—distant” based on predefined criterions.

In some embodiments of the invention, if multiple possible relations were found, the output may be associated with the strongest relation found.

It should be understood to a person skilled in the art that other operations or sets of operations may be used in accordance with embodiments of the invention.

An exemplary scenario that may describe the key indicator function of FIG. 6 may include a customer named John may send money from an internet café location in Lagos, Nigeria to another customer named Jane. John may have a Facebook profile that shows John's home address as being in North Carolina and does not mention any other locations. The transfer may be assigned with an output value of “no related location”, indicating high risk of fraud. If John's Facebook profile shows that John recently “checked in” from Lagos, Nigeria, the transfer may be assigned with an output of “related location—close”, indicating a low risk of fraud.

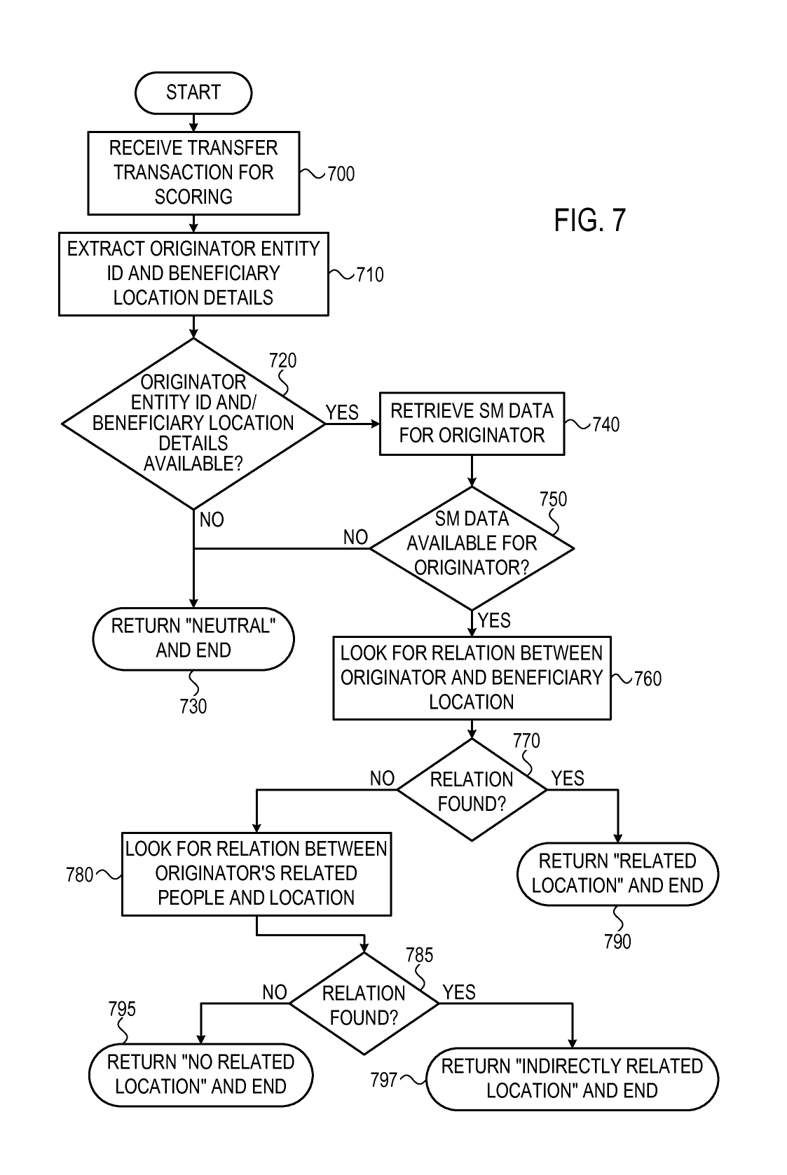

Reference is now made to FIG. 7, which is a flowchart of an exemplary key indicator function according to embodiments of the present invention. Operations of the method may be implemented, for example, by one or more of the elements in FIG. 2, for example, fraud risk estimator 112 and/or by other suitable units, devices, and/or systems.

As indicated at box 700, the key indicator function may include receiving a transaction (e.g., details or information related to the transaction) for scoring. According to embodiments of the invention, a transaction processing system, e.g., transaction system 260 may send a monetary transfer transaction (e.g., details or information related to the transaction) to scoring model 250 for risk scoring.

As indicated at box 710, the key indicator function may include extracting from the transaction details information of geographical location of the transaction beneficiary and entity ID of the originator of the transaction. Extraction of the details may be performed by, for example, scoring model 250. For example, if the transaction is a wire or interbank transfer, the geographical location may be the full or partial address of the beneficiary branch, or of the final beneficiary if specified, if the transaction is a bill payment via a printed check by mail, the geographical location may be the mailing address of the beneficiary, if the transaction is a transfer of money to be paid via a physical cash delivery to the beneficiary, the geographical location may be the delivery address of the beneficiary or if the transfer beneficiary has a mailing address that is known to the originating financial institution , e.g., an intrabank transfer or a bill payment to a known entity, the geographical location may be the mailing address of the beneficiary. Any other geographical location related to the beneficiary may be used. According to some embodiments, extracting details related to one or more parties of the transaction may include extracting details from information related to users of a company from a business management system, e.g., business management system 111 of FIG. 1.

As indicated at box 720, the key indicator function may include checking if the entity ID of the originator and the location information of the beneficiary are available. If no entity ID is available for originator and/or location information of the beneficiary is not available the key indicator function may include returning a “neutral” output value, indicating that no information could be determined regarding the transaction's risk and may end the function process as indicated at box 730.

If an entity ID of the originator and location information of the beneficiary are available, key indicator function may include querying the SMDR by scoring model, e.g., SMDR 240 and scoring model 250 and retrieving social media data related to the originator of the transaction as indicated at box 740.

As indicated at box 750, the function may include checking if social media data is available for originator, if no social media data is available for originator, the key indicator function may include returning a “neutral” output value, indicating that no information may be determined regarding the transaction's risk and may end the function process as indicated at box 730.

As indicated at box 760, if social media data is available for originator, the function may include analyzing the available social media data and looking for relation between the originator and the location information related to the beneficiary by, for example, scoring model 250. Any type of relation between the originator and location related to the beneficiary may be searched for and analyzed and, as indicated at box 770, the function may include checking if relation between the originator and the location information related to the beneficiary exists.

A first example for relation between the originator and location information related to the beneficiary may include geographically proximity of beneficiary location to originator's address, e.g., if one of the current or prior addresses in the originator's contact information may be geographically proximate to the beneficiary location. A close proximity may be predefined at a certain distance, e.g. less than 100 KM, and may indicate a strong relation, while a distant proximity may be predefined at a certain distance, e.g. between 100-1,000 KM may indicate a weaker relation. In such a case, the key indicator function may return an output of “related location” as indicated at box 790. According to some embodiments the function may return an output value which may correspond to the scenario, for example, an output “related address—close” or “related address—distant”.

A second example for relation between the originator and location information related to the beneficiary may include geographically proximity of the beneficiary to a mentioned location, e.g., if one of the originator's recently mentioned countries, addresses and other locations is geographically proximate to the beneficiary location. A close proximity may be predefined at a certain distance, e.g. less than 100 KM, and may indicate a strong relation, while a more distant proximity may be predefined at a certain distance, e.g. between 100-1,000 KM may indicate a weaker relation. In such a case, the key indicator function may return an output of “related location” and may end the function process as indicated at box 790. According to some embodiments the function may return an output value which may correspond to the scenario, for example, an output “related location—close” or “related location—distant”.

As indicated at box 780, if no relation is found between the originator and the beneficiary location information, the key indicator function may include looking for relation between one or more of the originator's related people and the beneficiary location information, for example, a geographically proximity of one of the originator's related people address to the beneficiary location information, or geographically proximity of one of the originator's related people mentioned location to the beneficiary location information. A relation between one or more of the originator's related people to the beneficiary location may indicate a weaker relation than if the originator had an equivalent direct relation to the beneficiary location.

As indicated at box 785, the key indicator function may include checking if relation between one or more of the originator's related people and the beneficiary location exists, if no relation was found, the key indicator function may return a “no related location” output that may indicate an increased risk that the transaction is fraudulent and may end the function process, as indicated at box 795. If a relation between one or more of the originator's related people and the beneficiary location exists, the key indicator function may return an output “indirectly related address” and may end the function process as indicated at box 797. According to some embodiments so the invention, the output may vary according to or based on predefined criterions of relations, for example, “indirectly related address—close” or “indirectly related address—distant” or “indirectly related location—close” or “indirectly related location—distant” based on predefined criterions.

In some embodiments of the invention, if multiple possible relations were found, the output may be associated with the strongest relation found.

It should be understood to a person skilled in the art that other operations or sets of operations may be used in accordance with embodiments of the invention.

An exemplary scenario that may describe the key indicator function of FIG. 7 may include a customer named John may send money to another customer named Jane to an account at a branch of a bank in Lagos, Nigeria. John may have a Facebook profile that shows John's home address as being in North Carolina and does not mention any other locations. The transfer may be assigned with an output value of “no related location”, indicating high risk of fraud. If John's profile also shows that John has 3 “friends” having a home address in Lagos, Nigeria, the transfer may be assigned with an output of “indirectly related location—close”, indicating a low risk of fraud.

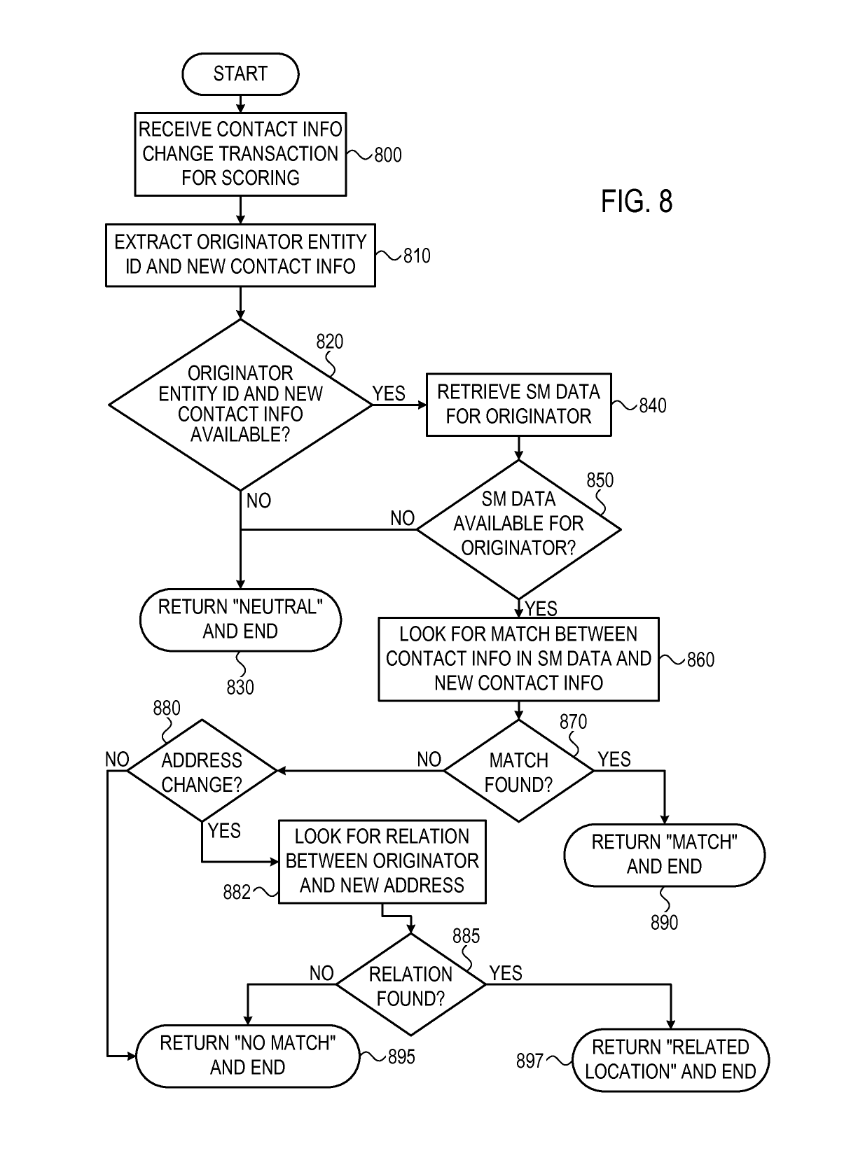

Reference is now made to FIG. 8, which is a flowchart of an exemplary key indicator function according to embodiments of the present invention. Operations of the method may be implemented, for example, by one or more of the elements in FIG. 2, for example, fraud risk estimator 112 and/or by other suitable units, devices, and/or systems.

As indicated at box 800, the key indicator function may include receiving a contact info change transaction for scoring. According to embodiments of the invention, a transaction processing system, e.g., transaction system 260 may send a contact info change transaction to scoring model 250 for risk scoring. For example, this contact info change transaction may indicate a new mailing address, e-mail address, telephone number, or any other contact information change for a given customer.

As indicated at box 810, the key indicator function may include extracting from the transaction details information entity ID of the originator of the transaction and the new contact information. Extraction of the details may be performed by, for example, scoring model 250. According to some embodiments, extracting details related to one or more parties of the transaction may include extracting details from information related to users of a company from a business management system, e.g., business management system 111 of FIG. 1.

As indicated at box 820, the key indicator function may include checking if the entity ID of the originator and new contact information are available. If no entity ID is available for originator and/or new contact information is not available the key indicator function may include returning a “neutral” output value, indicating that no information could be determined regarding the transaction's risk and may end the function process as indicated at box 830.

If an entity ID of the originator and new contact information are available, key indicator function may include querying the SMDR by scoring model, e.g., SMDR 240 and scoring model 250 and retrieving social media data related to the originator of the transaction as indicated at box 840.

As indicated at box 850, the function may include checking if social media data is available for originator, if no social media data is available for originator, the key indicator function may include returning a “neutral” output value, indicating that no information may be determined regarding the transaction's risk and may end the function process as indicated at box 830.

As indicated at box 860, if social media data is available for originator, the function may include analyzing the available social media data and looking for relation or similarities between the originator current social media contact information and the new contact information extracted from the transaction by, for example, scoring model 250.

Any type of relation and/or similarity between the originator current social media contact information and the new contact information extracted from the transaction may be searched for and analyzed and, as indicated at box 870, the function may include checking if there is a match or any similarity between the originator current social media contact information and the new contact information.

As indicated at box 890, if the new contact info matches the current social media contact information, the key indicator may return a “match” output, indicating a low risk that the transaction is fraudulent, because the new contact info is consistent with information from an independent source, e.g., the social media information and may end the function process.

If no match is found the function may include checking if the new contact info includes a new address that does not match the current social media contact information, if there is no address change the key indicator function may return a “no match” output and may end the function process as indicated at box 895. If the new contact info includes a new address the function may include looking for a relation between the originator and the new address location. For example, if a transaction from a location related to the new address or a transfer to a location related to the new address exists.

As indicated at box 885, the function may include checking if a relation is found. If a relation is found the key indicator function may return a “related location” output and may end the function process as indicated at box 897, indicating a low risk that the transaction is fraudulent, because the new contact info may be consistent with information from an independent source, e.g., the social media information. If the new contact info does not match the current social media contact information and no relation was found, the key indicator function may return a “no match” output and may end the function process as indicated at box 895, indicating a slightly increased risk that the transaction is fraudulent, because the new contact info is not consistent with information from an independent source, e.g., the social media information.

An exemplary scenario that may describe the key indicator function of FIG. 8 may include a customer named John updating his contact telephone number to (555) 333-1234, and John's Facebook profile shows John's telephone number is (555) 333-1234 (the same number), the contact info change may be assigned with an output of “match”, a positive relation, indicating low risk of fraud. If John's profile shows a different telephone number, the contact info change may be assigned with an output of “no match”, indicating a higher risk of fraud.

It should be understood to a person skilled in the art that other operations or sets of operations may be used in accordance with embodiments of the invention.

Some embodiments of the invention may be implemented, for example, using an article including or being a non-transitory machine-readable or computer-readable storage medium, having stored thereon instructions, that when executed on a computer, cause the computer to perform method and/or operations in accordance with embodiments of the invention. The computer-readable storage medium may store an instruction or a set of instructions that, when executed by a machine (for example, by a computer, a mobile device and/or by other suitable machines), cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Video Disks (DVDs), a tape, a cassette, or the like.

The modules and components may include one or more sets or collections of computer instructions, such as libraries, executables, modules, or the like, programmed in any programming language such as C, C++, C#, Java or others, and developed under any development environment, such as .Net, J2EE or others. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Alternatively, the apparatus and method may be implemented as firmware ported for a specific processor such as digital signal processor (DSP) or micro controllers, or may be implemented as hardware or configurable hardware such as field programmable gate array (FPGA) or application specific integrated circuit (ASIC). The software components may be executed on one platform or on multiple platforms wherein data may be transferred from one computing platform to another via a communication channel, such as the Internet, Intranet, Local area network (LAN), wide area network (WAN), or via a device such as CDROM, disk on key, portable disk or others.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A computer-implemented method for estimating fraud risk of transactions, the method comprising:
in one or more processors:
receiving from a transaction management system, transaction information related to a transaction, the transaction having an associated party;
comparing, by a fraud risk estimator, between the transaction information and social media information related to the associated party;
identifying by the fraud risk estimator a relation between the social media information and the transaction information using at least one key indicator function; and
calculating by the fraud risk estimator a risk score of the transaction, based on the relation.

2. The method of claim 1, comprising estimating a fraud risk, associated with the transaction, based on the risk score.

3. The method of claim 1, comprising:
searching for social media information related to a target based on social media identification of the target;
storing the social media information related to the target; and
after receiving from the transaction management system the transaction information, associating the social media information related to the target with the social media information related to the associated party, if the target matches the associated party.

4. The method of claim 3, comprising creating an association between the target and the social media identification of the target.

5. The method of claim 1, wherein the transaction is a financial transaction.

6. The method of claim 1, wherein the information related to the transaction comprises information related to identification of the associated party.

7. The method of claim 1, wherein the information related to the transaction comprises information related to a location of the associated party.

8.-9. (canceled)

10. The method of claim 1, wherein the transaction has a second associated party and the method comprises identifying a relation between social media information related to the associated party and social media information related to the second associated party.

11. One or more non-transitory computer-readable storage media comprising instructions that are executable to cause one or more processors to:
receive transaction information related to a transaction from a transactional system, the transaction having an associated party;
compare, by a fraud risk estimator, between the transaction information and social media information related to the associated Party;
identify by the fraud risk estimator a relation between the social media information and the transaction information using at least one key indicator function; and
calculate by the fraud risk estimator a risk score of the transaction, based on the relation.

12. The one or more non-transitory computer-readable storage media of claim 11, wherein the instructions when executed further cause one or more processors is to estimate a fraud risk, associated with the transaction, based on the risk score.

13. The one or more non-transitory computer-readable storage media of claim 11, wherein the instructions when executed further cause one or more processors to search for social media information related to a target based on social media identification of the target, to store the social media information related to the target and after receiving the transaction information to associate the social media information related to the target with the social media information related to the associated party, if the target matches the associated party.

14. The one or more non-transitory computer-readable storage media of claim 11, wherein the transaction is a financial transaction.

15. The one or more non-transitory computer-readable storage media of claim 11, wherein the information related to the transaction comprises information related to identification of the associated party.

16. The one or more non-transitory computer-readable storage media of claim 11, wherein the information related to the transaction comprises information related to the associated party.

17.-20. (canceled)
